(19) United States
(12) Patent Application Publication
(10) Pub. No.: US 2005/0114561 A1
(43) Pub. Date: May 26, 2005

(54) Method for performing DMA transfers with dynamic descriptor structure

(76) Inventors: Ho-Keng Lu, Hsinchu City (TW); Chia-Ming Chang, Hsinchu City (TW); Tsai-Pao Lee, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/720,403

(22) Filed: Nov. 24, 2003

(51) Int. Cl. G06F 13/28

(52) U.S. Cl. 710/24

(57) ABSTRACT

A method for performing DMA transfers with dynamic descriptor structure. A processor first creates a new chain of descriptors each including an end-of-chain (EOC) entry set to a false value except a dummy descriptor at the end of the new chain having the EOC entry set to a true value. The new descriptor chain can be appended to a previous descriptor chain, if any, by transferring parameters and a link pointer of the first descriptor within the new descriptor chain to a dummy descriptor of the previous descriptor chain. Then the processor changes the EOC entry of the dummy descriptor within the previous chain from the true value to the false value. Therefore, a DMA controller is able to transfer data in accordance with the new descriptor and also the previous one.

### BACKGROUND OF THE INVENTION

1. Field of the Invention

The invention relates to the field of direct memory access (DMA), and more particularly to a method for performing DMA transfers through dynamic appending descriptors without interruptions.

2. Description of the Related Art

In digital computer systems, it is common to use direct memory access (DMA) to transfer data between a system memory attached to a main system bus and input/output (I/O) devices. The direction of data transfer can be from the I/O device to memory, or vice versa. A DMA controller is generally used to transfer blocks of data between an I/O device and consecutive locations in the system memory. In order to perform a block transfer, the DMA device needs a starting address for the transfer, and a count of the number of data items, which may be bytes, words, or other units of information which can be transmitted in parallel on the computer system bus.

One simple method by which a DMA controller operates is where a host processor writes directly into the DMA controller using an I/O access with a special command. In this related art method, the host processor must continuously monitor the DMA start and end activities, leading to an inefficient use of processor time. Sophisticated DMA controllers typically use a linked list of control blocks in a memory to chain a sequence of DMA operations together. The control blocks, each of which conveys data-transfer parameters between a host processor and DMA controller, are data structures created by the host processor and accessed by the DMA controller for effecting a particular DMA operation. Often, while the DMA controller is performing a data transfer specified by a particular control block, the host processor specifies additional data transfers by creating additional control blocks. When additional control blocks are created, it is desirable to append the new control blocks to the existing linked list of control blocks to allow the DMA controller to process all the control blocks in one uninterrupted sequence of data transfer operations.

The appending of control block(s) to an existing linked list before completion of a corresponding DMA operation is referred to as dynamic chaining of DMA operations. The. transfer of high-speed streaming data (such as multimedia data in storage and network technologies) requires frequent dynamic DMA chaining. The implementation of dynamic DMA chaining, however, suffers from poor performance as the DMA controller actually suspends operations during the chaining process in order to prevent race conditions. Such a condition refers to a situation where a control block can be inadvertently omitted from its intended position within a given sequence of data-transfer operations (and thereby missed during processing) due to the timing of at least two events.

In view of the above, there is a need for an efficient method of performing DMA transfers which overcomes the disadvantages of the related art. Specifically, it would be desirable to facilitate DMA operations without suspending a DMA controller or incurring race conditions, which also eliminates with the need for a host processor to continuously monitor and poll the DMA activities.

### SUMMARY OF THE INVENTION

The present invention is generally directed to a method for performing DMA transfers with dynamic descriptor structure. According to one aspect of the invention, a new chain of descriptors is created where each descriptor includes an end-of-chain (EOC) entry set to a false value except a dummy descriptor at the end of the new chain having the EOC entry set to a true value. Apart from the dummy descriptor, each of the descriptors further comprises one or more parameters identifying data to be transferred and a link pointer specifying a next descriptor within the descriptor chain. The new descriptor chain can be appended to a previous descriptor chain, if any, by transferring the parameters and the link pointer of the first descriptor within the new descriptor chain to a dummy descriptor of the previous descriptor chain. Then the EOC entry of the dummy descriptor within the previous chain is changed from the true value to the false value. After that, the descriptor specified by a next address is fetched from the previous chain appended by the new one. The currently fetched descriptor is examined to determine whether its EOC entry is set to the false value. If so, the next address is updated with the link pointer of the currently fetched descriptor. The data identified in the parameters of the currently fetched descriptor is also transferred.

According to another aspect of the invention, a method for performing DMA transfers under control of a DMA controller and a processor is disclosed. The processor first creates a new chain of descriptors each including an end-of-chain (EOC) entry set to a false value except a dummy descriptor at the end of the new chain having the EOC entry set to a true value. Apart from the dummy descriptor, each of the descriptors further comprises one or more parameters identifying data to be transferred by the DMA controller and a link pointer specifying a next descriptor within the descriptor chain. The processor next causes a starting address to point to the first descriptor within the descriptor chain and then issues a start command. If the DMA controller is in an idle state, it will accept the start command and replace a next address with the starting address. After that, the descriptor specified by the next address is fetched from the descriptor chain. The currently fetched descriptor is examined to determine whether its EOC entry is set to the false value. If so, the next address is updated with the link pointer of the currently fetched descriptor. Also, the data identified in the parameters of the currently fetched descriptor is transferred by the DMA controller now. The steps of fetching through transferring are repeated until the EOC entry with the true value is detected in the determining step.

According to yet another aspect of the invention, a processor first creates a new chain of descriptors each including an end-of-chain (EOC) entry set to a false value except a dummy descriptor at the end of the new chain having the EOC entry set to a true value. Each of the descriptors further comprises one or more parameters identifying data to be transferred by a DMA controller and a link pointer specifying a next descriptor within the descriptor chain. The processor next makes a next address pointed to the first descriptor within the descriptor chain and then issues a command. If the DMA controller is in an idle state, it will accept the issued command. The descriptor specified by the next address is then read from the descriptor chain and the data identified in the parameters of the currently read descriptor is transferred as well. After that, the currently read descriptor is examined to determine whether its EOC entry is set to the false value. If so, the next address is updated with the link pointer of the currently read descriptor. The steps of reading through updating are repeated until the EOC entry with the true value is detected in the determining step.

### DESCRIPTION OF THE DRAWINGS

The present invention will be described by way of exemplary embodiments, but not limitations, illustrated in the accompanying drawings in which like references denote similar elements, and in which:

FIG. 1 is a block diagram of an exemplary computer system in accordance with the invention;

FIG. 2 is a block diagram of a descriptor configured in accordance with an embodiment of the invention;

FIG. 3A is a block diagram illustrating two chains of descriptors specifying data transfers to be performed by the DMA controller of FIG. 1 in accordance with an arrangement of the invention;

FIG. 3B is a block diagram illustrating two chains of descriptors specifying data transfers to be performed by the DMA controller of FIG. 1 in accordance with another arrangement of the invention;

FIGS. 4A and 4B are flowcharts illustrating processor and DMA primary operations, respectively, in accordance with an embodiment of the invention;

FIGS. 5A and 5B are flowcharts illustrating processor and DMA primary operations, respectively, in accordance with another embodiment of the invention; and

FIGS. 6A and 6B are flowcharts illustrating processor and DMA primary operations, respectively, in accordance with yet another embodiment of the invention.

### DETAILED DESCRIPTION OF THE INVENTION

With reference to the accompanying figures, exemplary embodiments of the invention will now be described. The exemplary embodiments are described primarily with reference to block diagrams and flowcharts. As to the flowcharts, each block within the flowcharts represents both a method step and an apparatus element for performing the method step. Herein, the apparatus element may be referred to as a means for, an element for, or a unit for performing the method step. Depending upon the implementation, the apparatus element, or portions thereof, may be configured in hardware, software, firmware or combinations thereof. As to the block diagrams, it should appreciated that not all components necessary for a complete implementation of a practical system are illustrated or described in detail. Rather, only those components necessary for a thorough understanding of the invention are illustrated and described. Furthermore, components which are either conventional or may be readily designed and fabricated in accordance with the teachings provided herein are not described in detail.

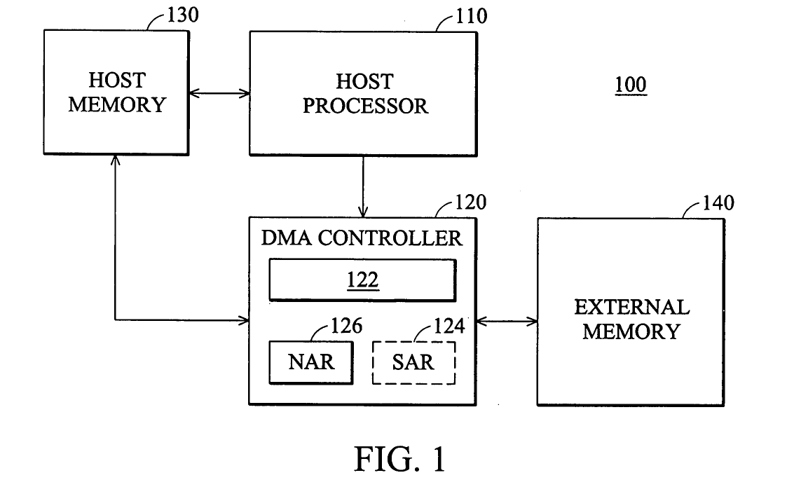

FIG. 1 illustrates a simplified computer system 100 including a host processor 110 and a DMA controller 120 which handles data transfers between a host memory 130 and an external memory 140. The DMA controller 120 processes data transfer operations specified by descriptor data structures created by the host processor 110 and stored in the host memory 130. The descriptors are created in chains with each individual descriptor including one or more parameters identifying data to be transferred and a link pointer specifying the memory address of a next descriptor within the chain. In addition, each descriptor bears an end-of-chain (EOC) entry which will be illustrated in detail below. The host processor 110 is capable of issuing two DMA related commands: start command and resume command, to notify the DMA controller 120 that a new descriptor chain to be processed has been created or appended. The DMA controller 120 should include a state machine 122 which responds to the two commands. Note that the start and resume commands in accordance with the invention are of a memoryless type. In this regard, the DMA controller 120 does not need to deal with the two commands while receiving them in a busy state such that the start or resume command is ignored and dropped at the time. Therefore, the two commands of the memoryless type are accepted only if the DMA controller 120 is in an idle or wait state. As shown in FIG. 1, the DMA controller 120 also has a next address register (NAR) 126 to hold the address of a next descriptor to be processed within a chain of descriptors. Optionally, a starting address register (SAR) 124 is implemented in the DMA controller 120 to store the address of the first descriptor within a chain of descriptors to be performed.

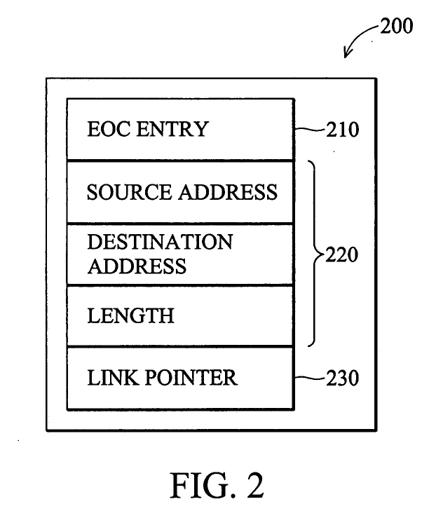

FIG. 2 illustrates an exemplary descriptor in accordance with the invention. The exemplary descriptor 200 comprises an EOC entry 210, a link pointer 230, and several data-transfer parameters 220. The EOC entry 210 is used to indicate whether the descriptor associated therewith is the last one within a chain of descriptors. If no additional descriptors are in the descriptor chain, the host processor 110 sets the EOC entry 210 to a true value or other suitable default value so as to mark the end of the chain. Otherwise, the EOC entry 210 is set to a false value. The DMA controller 120 is capable of checking the EOC entry of each descriptor to see if it reaches the end of a descriptor chain. The link pointer 230 is provided to identify the next descriptor within a chain of descriptors. The link pointer 230 has no meaning when the related EOC entry is set to the true value. The parameters 220 may include, for example, the source address of a block of data to be transferred, the destination address to which the data is to be transferred, and the length of the data block to be transferred.

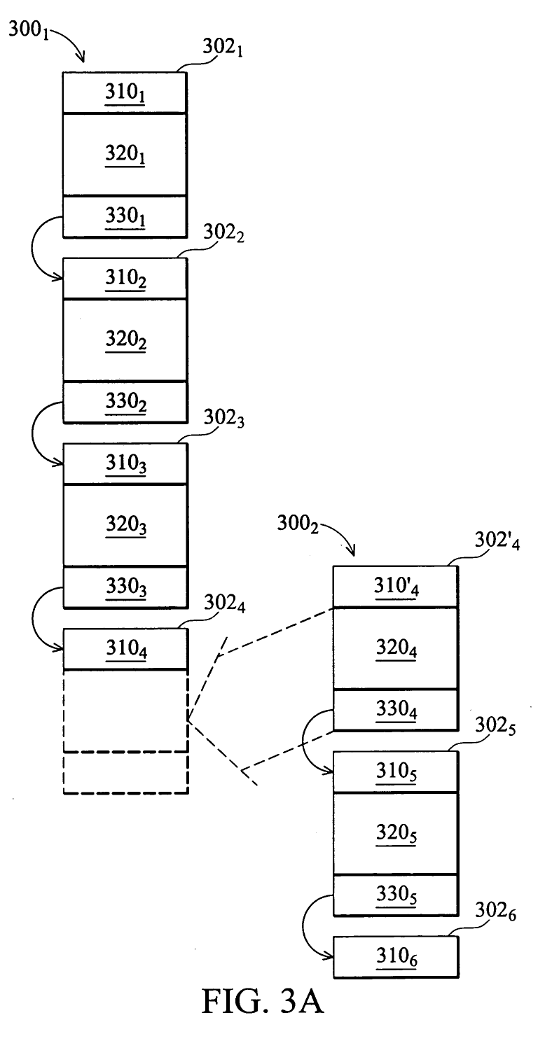

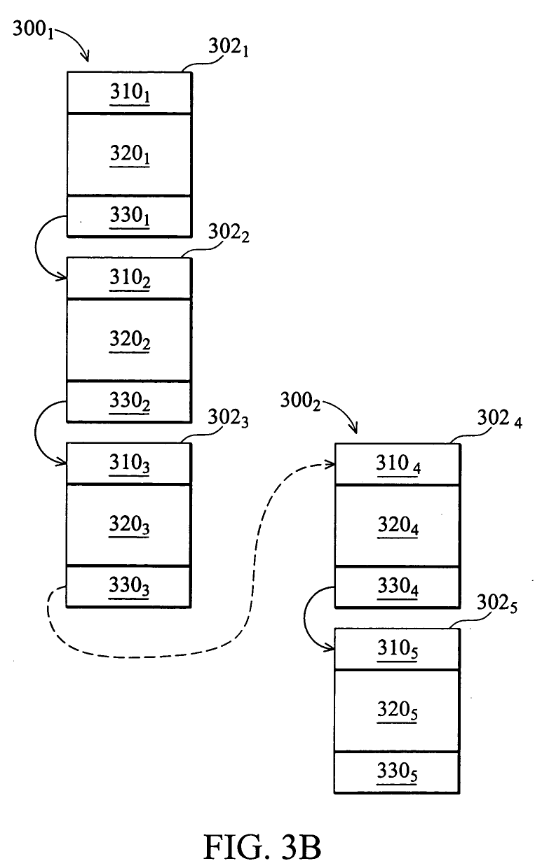

FIG. 3A illustrates a first chain of descriptors 3001, for example, with four descriptors identified by reference numerals 302₁ through 302₄. As the exemplary descriptor 200 of FIG. 2, the descriptors 302₁-302₃ are configured to include EOC entries 310₁-310₃, data-transfer parameters 320₁-320₃ and link pointers 330₁-330₃, respectively. Each of the EOC entries 310₁-310₃ is set to the false value indicating that there are other descriptors in the chain 300₁. In accordance with the invention, the last descriptor 302₄ at the end of the chain 300₁ is called the dummy descriptor which contains an EOC entry 310₄ set to the true value. In FIG. 3A, an additional chain of descriptors 300₂, is shown with three descriptors 302₄′, 302₅, and 302₆. Similarly, the descriptors 302₄′-302₅ have EOC entries 310₄′-310₅, parameters 320₄-320₅ and link pointers 330₄-330₅, respectively, while the dummy descriptor 302₆ at the end of the chain 300₂ includes an EOC entry 310₆ set to the true value. When the host processor creates the additional descriptor chain, it is desirable to append the new descriptor chain to the previous descriptor chain so as to allow the DMA controller to process all the descriptors in one uninterrupted sequence of data transfers. To this end, the host processor transfers the parameters 320₄ and the link pointer 330₄ of the first descriptor 302₄′ within the new chain 300₂ to the dummy descriptor 302₄ of the previous chain 300₁. After that, the host processor must further change the EOC entry 310₄ of the dummy descriptor 302₄ from the true value to the false value. Hence the dummy descriptor 302₄ is turned into the ordinary one and the new descriptor chain 300₂ is thereby appended to the previous chain 300₁. The appending operation is transparent to the DMA controller in accordance with the invention. In this case, the DMA controller will keep processing the previous chain 300₁ and also the new chain 300₂ without any state change provided that the descriptor 302₄ is not fetched prior to the update of the EOC entry 310₄.

FIG. 3B illustrates an alternative configuration for descriptor chains. There is no dummy descriptor at the end of each descriptor chain. Instead, as shown in FIG. 3B, every chain of descriptors is ended with an ordinary descriptor having an EOC entry set to the true value. To append a new chain 300₂ to a previous chain 300₁, the host processor copies the address of the first descriptor 302₄ within the new chain 300₂ into the link pointer 330₃ of the last descriptor 302₃ within the previous chain 300₁. Further, the host processor changes the EOC entry 310₃ from the true value to the false value. As a result, the new descriptor chain 300₂ is appended to the previous chain 300₁. The appending operation is transparent to the DMA controller in accordance with the invention. In the example of FIG. 3B, the DMA controller will keep processing the previous chain 300₁ and also the new chain 300₂ without any state change provided that the descriptor 302₃ is not fetched prior to the update of the EOC entry 310₃.

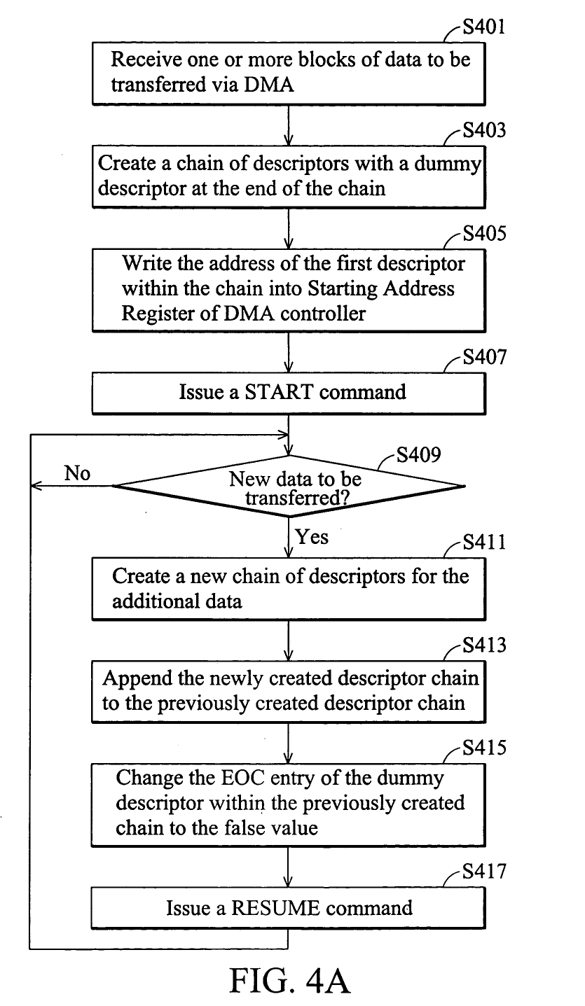

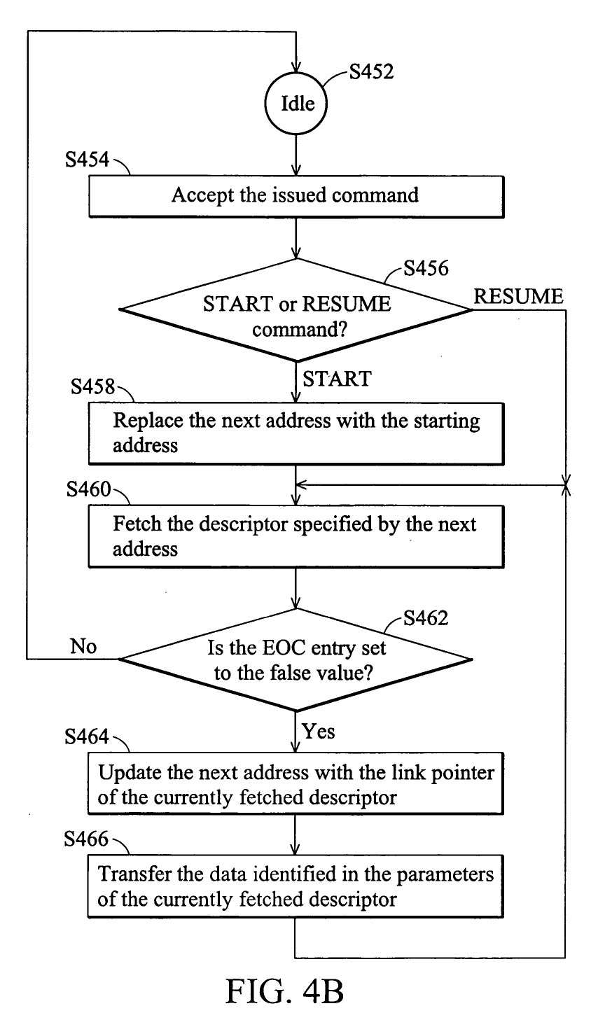

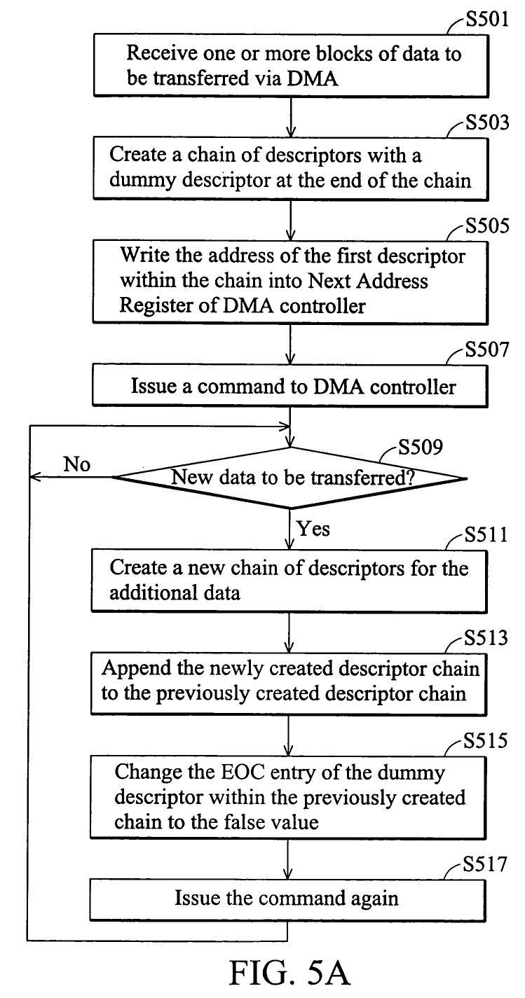

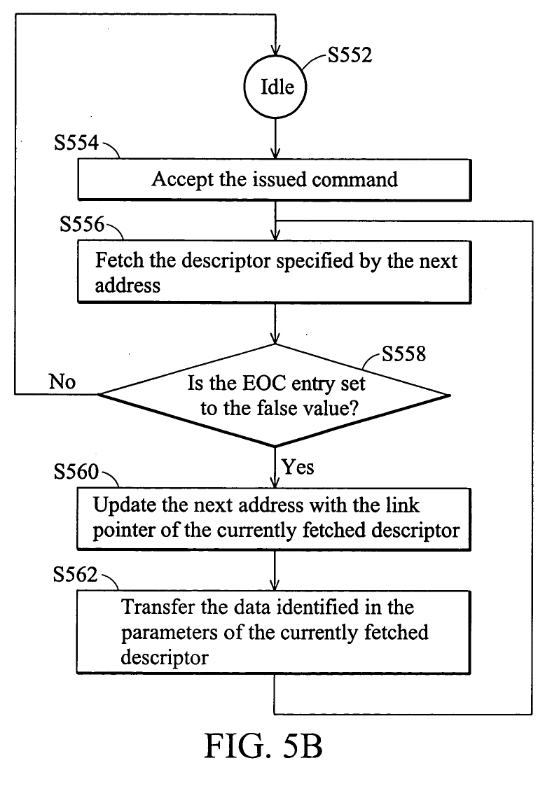

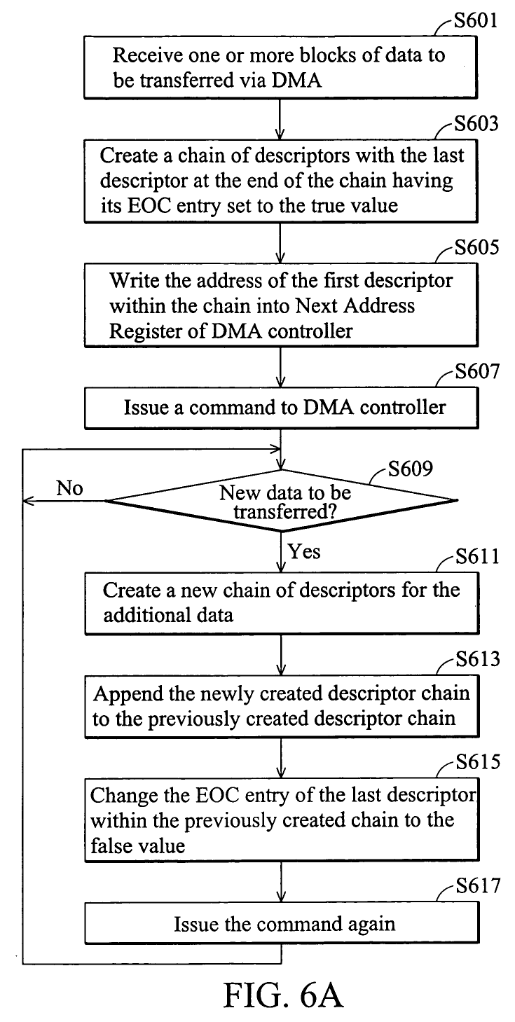

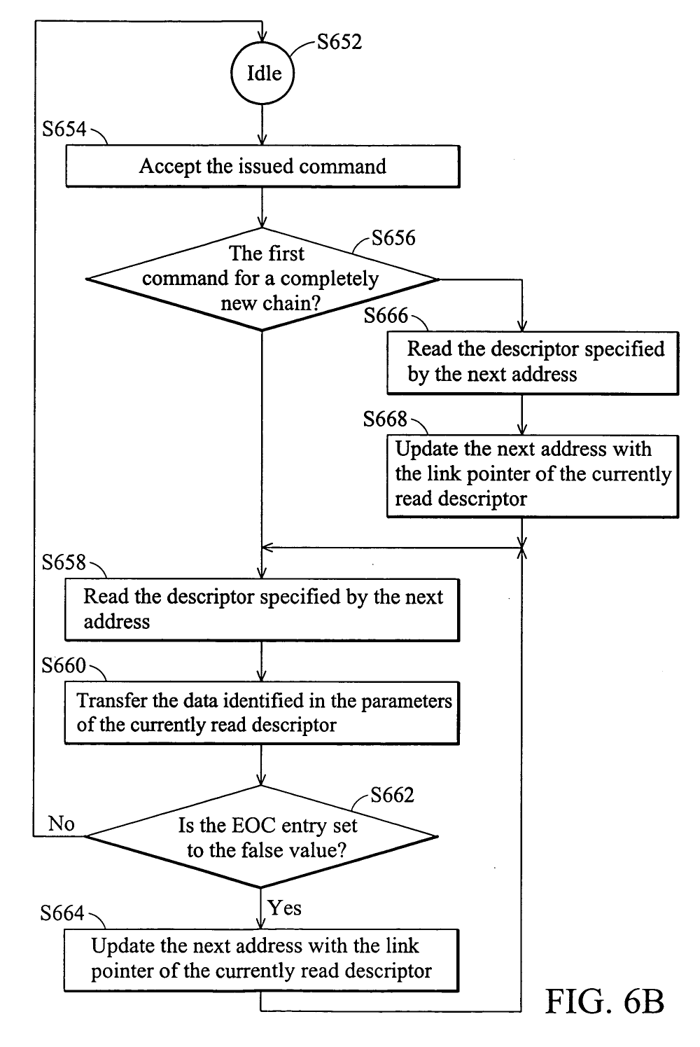

Various methods by which the host processor 110 and the DMA controller 120 of FIG. 1 operate to facilitate DMA transfers will now be described with reference to FIGS. 4A-6B. FIGS. 4A, 5A and 6A represent method steps of the host processor 110 while FIGS. 4B, 5B and 6B represent complementary method steps, respectively, of the DMA controller 120. These steps may be performed in parallel as the host processor 110 and the DMA controller 120 are separate asynchronous devices. Reference to “chain” or “descriptor chain” in the following discussion refers to data structures stored in the host memory 130 containing one or more descriptors. The embodiments described in connection with FIGS. 4A-5B utilize a chain of descriptors ended with a dummy descriptor as illustrated in FIG. 3A. Alternatively, FIGS. 6A and 6B utilize a chain of descriptors without a dummy descriptor as illustrated in FIG. 3B. Moreover, the embodiment set forth in FIGS. 4A and 4B is similar to those illustrated in FIGS. 5A-6B, with the notable exception that FIGS. 4A and 4B adopt the use of an optional SAR in the DMA controller 120 and apply both start and resume commands.

FIG. 4A illustrates primary operational steps executed by the host processor 110 in accordance with a first embodiment of the invention. Initially, in step S401, the host processor 110 receives one or more blocks of data to be transferred via the DMA controller 120 from one memory to another. In step S403, the host processor 110 creates a chain of descriptors each including an EOC entry set to a false value except a dummy descriptor at the end of the new chain having its EOC entry set to a true value. In all embodiments illustrated herein, each of the descriptors excluding the dummy descriptor is configured as the example of FIG. 2. The host processor 110 then proceeds to step S405 where it places the address of the first descriptor within the chain into the SAR 124 of the DMA controller 120. Next, the host processor 110 initiates DMA transfer by issuing a start command in step S407. After that, the host processor 110 proceeds to step S409 where it awaits new data to be transferred. When additional data becomes available pursuant to step S409, the host processor 110 creates a new chain of descriptors in step S411 for the additional data. Proceeding to step S413, the host processor 110 appends the newly created descriptor chain to the previously created descriptor chain, where the parameters and the link pointer of the first descriptor within the newly created chain are transferred to the dummy descriptor of the previously created chain. In step S415, the host processor 110 changes the EOC entry of the dummy descriptor within the previously created chain from the true value to the false value. Then, the host processor 110 issues a resume command in step S417.

FIG. 4B illustrates primary operational steps executed by the DMA processor 120 in accordance with the first embodiment of the invention. Initially, in step S452, the DMA processor 120 is in an idle state or wait state. If so, the DMA controller 120 is enabled to proceed to step S454 where it accepts the start or resume command. In step S456, the DMA controller 120 checks the accepted command to see which command is issued from the host processor 110. If the accepted command is the start command, the DMA controller 120 proceeds to step S458 where it copies the SAR 124 into the NAR 126 so that a next address is replaced with a starting address. Also, in step S460, the DMA controller 120 fetches the descriptor specified by the next address from the descriptor chain. If the accepted command is the resume command, on the other hand, the DMA controller 120 proceeds to step S460 directly. Note that the DMA controller 120 maintains the NAR 126 independently. In step S462, the DMA controller 120 examines the currently fetched descriptor to determine whether its EOC entry is set to the false value. If so, the DMA controller 120 proceeds to steps S464 and S466 where it updates the next address stored in NAR 126 with the link pointer of the currently fetched descriptor and transfers the data identified in the parameters of the currently fetched descriptor, respectively. Execution of steps S460-S466 continues in a loop until an EOC entry with the true value is detected in step S462. Once the DMA controller 120 reaches a dummy descriptor having the EOC entry set to the true value, meaning the DMA transfer identified in a chain including the appended one, if any, is completed. Notably, the appending operation is transparent to the DMA controller 120 in accordance with the invention. The DMA controller 120 ignores the commands when it is performing the data transfer identified in a descriptor chain. If there are no more data transfers identified in the chain, the DMA controller 120 returns to step S452 and accepts a newly issued command in step S454. Accordingly, the DMA controller is capable of processing all the descriptors in one uninterrupted sequence of data transfers.

FIG. 5A illustrates primary operational steps executed by the host processor 110 in accordance with a second embodiment of the invention. Initially, in step S501, the host processor 110 receives one or more blocks of data to be transferred via the DMA controller 120 from one memory to another. In step S503, the host processor 110 creates a chain of descriptors each including an EOC entry set to a false value except a dummy descriptor at the end of the new chain having its EOC entry set to a true value. The host processor 110 then proceeds to step S505 where it places the address of the first descriptor within the chain into the NAR 124 of the DMA controller 120. Next, the host processor 110 initiates DMA transfer by issuing a command in step S507. After that, the host processor 110 proceeds to step S509 where it awaits transfer of new data. When additional data becomes available pursuant to step S509, the host processor 110 creates a new chain of descriptors in step S511 for the additional data. Proceeding to step S513, the host processor 110 appends the newly created descriptor chain to the previously created descriptor chain, where the parameters and the link pointer of the first descriptor within the newly created chain are transferred to the dummy descriptor of the previously created chain. In step S515, the host processor 110 changes the EOC entry of the dummy descriptor within the previously created chain from the true value to the false value. Then, the host processor 110 issues the command again in step S517.

FIG. 5B illustrates primary operational steps executed by the DMA processor 120 in accordance with the second embodiment of the invention. Initially, in step S552, the DMA processor 120 is in an idle state or wait state. If so, the DMA controller 120 is enabled to proceed to step S554 where it accepts the command issued from the host processor 110. Subsequently, in step S556, the DMA controller 120 fetches the descriptor specified by the next address in the NAR 126. After that, the DMA controller 120 maintains the NAR 126 by itself. In step S558, the DMA controller 120 examines the currently fetched descriptor to determine whether its EOC entry is set to the false value. If so, the DMA controller 120 proceeds to step S560 where it updates the next address stored in NAR 126 with the link pointer of the currently fetched descriptor. Also, the DMA controller 120 transfers the data identified in the parameters of the currently fetched descriptor in step S562. Execution of steps S556-S562 continues in a loop until an EOC entry with the true value is detected in step S558. From FIGS. 5A and 5B, it can be seen that the appending operation is transparent to the DMA controller 120. The DMA controller 120 ignores the commands when it is performing the data transfer identified in a descriptor chain. If there are no more data transfers identified in the chain, the DMA controller 120 returns to step S552 and accepts a newly issued command in step S554. Accordingly, the DMA controller is capable of processing all the descriptors in one uninterrupted sequence of data transfers.

FIGS. 6A and 6B illustrate methods carried by the host processor 110 and the DMA controller 120, respectively, to perform DMA transfers in accordance with a third embodiment of the invention. This embodiment is similar to those disclosed in FIGS. 4A-5B with the distinction that the embodiment of FIGS. 6A and 6B does not utilize a dummy descriptor. With reference to FIG. 6A, primary operational steps executed by the host processor 110 are illustrated. Initially, in step S601, the host processor 110 receives one or more blocks of data to be transferred via the DMA controller 120 from one memory to another. In step S603, the host processor 110 creates a chain of descriptors each including an EOC entry set to a false value except the last descriptor within the created chain having its EOC entry set to a true value. The host processor 110 then proceeds to step S605 where it places the address of the first descriptor within the chain into the NAR 124 of the DMA controller 120. Next, the host processor 110 initiates DMA transfer by issuing a command in step S607. After that, the host processor 110 proceeds to step S609 where it awaits new data to be transferred. When additional data becomes available pursuant to step S609, the host processor 110 creates a new chain of descriptors in step S611 for the additional data. Proceeding to step S613, the host processor 110 appends the newly created descriptor chain to the previously created descriptor chain, where the link pointer of the last descriptor within the previously created descriptor chain is made to point to the first descriptor within the newly created descriptor chain. In step S615, the host processor 110 changes the EOC entry of the last descriptor within the previously created chain from the true value to the false value. Then, the host processor 110 issues the command again in step S617.

Turning now to FIG. 6B, primary operational steps executed by the DMA processor 120 are illustrated. Initially, in step S652, the DMA processor 120 is in an idle state or wait state. The DMA controller 120 is therefore enabled to proceed to step S654 where it accepts the command issued from the host processor 110. In step S656, the DMA controller 120 determines whether the accepted command is the first one issued for a completely new chain. If so, the DMA controller 120 proceeds to step S658 where it reads the descriptor specified by the next address in the NAR 126. Next, in step S660, the DMA controller 120 transfers the data identified in the parameters of the currently read descriptor. In step S662, the DMA controller 120 examines the currently read descriptor to determine whether its EOC entry is set to the false value. If so, the DMA controller 120 proceeds to step S664 where it updates the next address stored in NAR 126 with the link pointer of the currently read descriptor. Execution of steps S658-S664 continues in a loop until an EOC entry with the true value is detected in step S662. On the other hand, the DMA controller 120 proceeds to step S666 if it determines that the accepted command is the subsequent one issued for an appended chain. Therefore, the DMA controller 120 first reads the descriptor specified by the next address in NAR 126 and then, in step S668, updates the next address with the link pointer of the currently read descriptor. Control then flows to step S658 and execution continues as described above. As can be seen in FIGS. 6A and 6B, the appending operation is transparent to the DMA controller 120 in accordance with the invention. The DMA controller 120 ignores the commands when it is performing the data transfer identified in a descriptor chain. If there are no more data transfers identified in the chain, the DMA controller 120 returns to step S652 and accepts a newly issued command in step S654. In view of the above, the DMA controller is capable of processing all the descriptors in one uninterrupted sequence of data transfers.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for performing DMA transfers with dynamic descriptor structure, comprising the steps of:
creating a new chain of descriptors each including an end-of-chain entry set to a false value except a dummy descriptor at the end of the new chain having the end-of-chain entry set to a true value, wherein each of the descriptors excluding the dummy descriptor further comprises one or more parameters identifying data to be transferred and a link pointer specifying a next descriptor within the new chain;
appending the new descriptor chain to a previous descriptor chain, if any, by transferring the parameters and the link pointer of the first descriptor within the new descriptor chain to a dummy descriptor of the previous descriptor chain;
changing the end-of-chain entry of the dummy descriptor within the previous descriptor chain from the true value to the false value;
fetching the descriptor specified by a next address;
determining whether the end-of-chain entry of the currently fetched descriptor is set to the false value;
if so, updating the next address with the link pointer of the currently fetched descriptor; and
transferring the data identified in the parameter of the currently fetched descriptor.

2. The method as recited in claim 1 further comprising the step of issuing a command after the new descriptor chain is appended to the previous descriptor chain.

3. The method as recited in claim 2 further comprising the step of causing the next address to point to the first descriptor within the new descriptor chain before the issuing step.

4. The method as recited in claim 2 further comprising the step of ignoring the issued command if the data transfer identified in the previous descriptor chain is being performed.

5. The method as recited in claim 2 further comprising the step of accepting the issued command if there are no more data transfers identified in the previous descriptor chain.

6. The method as recited in claim 1 wherein the fetching step through the transferring step are executed in a loop until the end-of-chain entry with the true value is detected in the determining step.

7. The method as recited in claim 5 wherein, after acceptance of the issued command, the fetching step through the transferring step are executed in a loop until the end-of-chain entry with the true value is detected in the determining step.

8. A method for performing DMA transfers under control of a DMA controller and a processor, the method comprising the steps of:
creating a chain of descriptors each including an end-of-chain entry set to a false value except a dummy descriptor at the end of the descriptor chain having the end-of-chain entry set to a true value, wherein each of the descriptors excluding the dummy descriptor further comprises one or more parameters identifying data to be transferred by the DMA controller and a link pointer specifying a next descriptor within the descriptor chain;
causing a starting address to point to the first descriptor within the descriptor chain;
issuing a start command by the processor;
accepting the start command by the DMA controller which is in an idle state;
replacing a next address with the starting address;
from the descriptor chain, fetching the descriptor specified by the next address;
determining whether the end-of-chain entry of the currently fetched descriptor is set to the false value;
if so, updating the next address with the link pointer of the currently fetched descriptor;
transferring the data identified in the parameters of the currently fetched descriptor; and
repeating the fetching through the transferring steps until the end-of-chain entry with the true value is detected in the determining step.

9. The method as recited in claim 8 further comprising the steps of:
creating a new chain of descriptors;
appending the newly created descriptor chain to the previously created descriptor chain by transferring parameters and a link pointer of the first descriptor within the newly created descriptor chain to the dummy descriptor of the previously created descriptor chain;
changing the end-of-chain entry of the dummy descriptor within the previously created descriptor chain from the true value to the false value;
issuing a resume command by the processor; and
ignoring the resume command if the data transfer identified in the previously created descriptor chain is being performed by the DMA controller.

10. The method as recited in claim 9 further comprising the step of accepting the resume command by the DMA controller if there are no more data transfers identified in the previously created descriptor chain.

11. The method as recited in claim 10 wherein, after acceptance of the resume command, the fetching through the transferring steps are resumed in a loop until the end-of-chain entry with the true value is detected in the determining step.

12. A method for performing DMA transfers under control of a DMA controller and a processor, the method comprising the steps of:
creating a chain of descriptors each including an end-of-chain entry set to a false value except the last descriptor within the descriptor chain having the end-of-chain entry set to a true value, wherein each of the descriptors further comprises one or more parameters identifying data to be transferred by the DMA controller and a link pointer specifying a next descriptor within the descriptor chain;
causing a next address to point to the first descriptor. within the descriptor chain;
issuing a command by the processor;
accepting the issued command by the DMA controller which is in an idle state;
from the descriptor chain, reading the descriptor specified by the next address;
transferring the data identified in the parameters of the currently read descriptor;
determining whether the end-of-chain entry of the currently read descriptor is set to the false value;
if so, updating the next address with the link pointer of the currently read descriptor; and
repeating the reading through the updating steps until the end-of-chain entry with the true value is detected in the determining step.

13. The method as recited in claim 12 further comprising the steps of:
creating a new chain of descriptors;
appending the newly created descriptor chain to the previously created descriptor chain by causing the link pointer of the last descriptor within the previously created descriptor chain to point to the first descriptor within the newly created descriptor chain;
changing the end-of-chain entry of the last descriptor within the previously created descriptor chain from the true value to the false value;
issuing the command by the processor; and
ignoring the issued command if the data transfer identified in the previously created descriptor chain is being performed by the DMA controller.

14. The method as recited in claim 13 further comprising the steps of:
if there are no more data transfers identified in the previously created descriptor chain:
accepting the issued command by the DMA controller;
fetching the descriptor specified by the next address; and
replacing the next address with the link pointer of the currently fetched descriptor.

15. The method as recited in claim 14 wherein, once the issued command is accepted by the DMA controller, the reading step through the updating step are executed in a loop until the end-of-chain entry with the true value is detected in the determining step.
